(19) United States
(12) Patent Application Publication
(10) Pub. No.: US 2011/0027513 A1
(43) Pub. Date: Feb. 3, 2011

(54) Self-Over-Laminating, THT- and Laser Printable Wire Markers Comprising Polyolefin Material

(76) Inventors: Chaujin Tan, Singapore (SG); Shiliang Fan, Singapore (SG)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/721,732

(22) Filed: Mar. 11, 2010

Related U.S. Application Data
(60) Provisional application No. 61/229,464, filed on Jul. 29, 2009.

(51) Int. Cl. B32B 33/00; B32B 17/10

(52) U.S. Cl. 428/41.3; 428/40.1; 428/339

(57) ABSTRACT

A halogen-free, wire-marking, multilayered label or tag comprises:

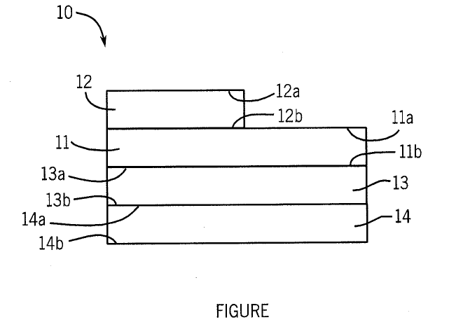

A. A facestock layer having top and bottom planar surfaces, the facestock layer comprising at least one of polyethylene and polypropylene;

B. An ink topcoat layer having top and bottom planar surfaces with the bottom planar surface of the ink topcoat layer in direct contact with at least a part but less than all of one of the top planar surface of the facestock layer;

C. An optional adhesive layer having top and bottom planar surfaces with the top planar surface of the optional adhesive layer in direct contact with at least part of the bottom planar surface of the facestock layer; and

D. An optional release liner having top and bottom planar surfaces with the top planar surface of the optional release liner in direct contact with the bottom planar surface of the optional adhesive layer.

### CROSS REFERENCE TO RELATED APPLICATION

This application claims priority to U.S. provisional patent application Ser. No. 61/229,464 filed on Jul. 29, 2009, the entire content of which is incorporated by reference herein.

### FIELD OF THE INVENTION

This invention relates to labels. In one aspect, the invention relates to labels for use as wire markers while in another aspect, the invention relates to halogen-free wire marker labels.

### BACKGROUND OF THE INVENTION

Conventionally, polyvinyl chloride (PVC) is used as a labeling material for wire and cable identifications purposes. PVC has very good conformity and with sufficient adhesion, the material is well-suited for wrap-around, wire marking applications. In addition it also demonstrates good weathering properties that allow its use in outdoor applications.

Over the past few years, however, an increasing demand for halogen-free material has occurred in response to various regulatory requirements. Thus, the wire marking industry is moving away from the use PVC, and the industry is constantly searching for replacement materials for use in the construction of wire marking labels.

### BRIEF SUMMARY OF THE INVENTION

In one embodiment the invention is a halogen-free wire-marking label.

In one embodiment the invention is a halogen-free, wire-marking, multilayered label or tag comprising:

A. A facestock layer having first or top and second or bottom planar surfaces, the facestock layer comprising at least one of polyethylene (PE) and polypropylene (PP);

B. A topcoat layer having first or top and second or bottom planar surfaces with the bottom planar surface of the topcoat layer in direct contact with at least a part but less than all of one of the top planar surface of the facestock layer;

C. An optional adhesive layer having first or top and second or bottom planar surfaces with the top planar surface of the optional adhesive layer in direct contact with at least part of the bottom planar surface of the facestock layer; and

D. An optional release liner having first or top and second or bottom planar surfaces with the top planar surface of the optional release liner in direct contact with the bottom planar surface of optional adhesive layer.

The topcoat layer is typically opaque, e.g., white, and can receive ink by any suitable means including thermal heat transfer (THT) printing and laser printing. Adhesion of the topcoat layer to the facestock layer is designed such that the topcoat layer does not peel-off within the first 30 seconds of attachment to the facestock layer. This allows time for repositioning the label if it incorrectly applied to the wire in the first instance.

### BRIEF DESCRIPTION OF THE FIGURE

The FIGURE is a schematic of a halogen-free, multilayered wire-marking label

### DETAILED DESCRIPTION OF THE PREFERRED EMBODIMENT

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, temperature and/or thickness ranges, etc., is from 100 to 1,000, then the intent is that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the thickness of the individual layers and the temperature ranges at which the layers are printed, coated or laminated to one another.

“Composition” and like terms mean a mixture or blend of two or more components.

“Polymer blend” and like terms mean a blend of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Planar surface”, “facial surface”, “top surface”, “bottom surface” and the like are used in distinction to “edge surface”. If rectangular in shape or configuration, a label will comprise two opposing planar surfaces joined by four edge surfaces (two opposing pairs of edge surfaces, each pair intersecting the other pair at right angles). If circular in configuration, then the label will comprise two opposing planar surfaces joined by one continuous edge surface. The labels can be of any size and shape and as such, so can the planar and edge surfaces, e.g., thin or thick, polygonal or circular, flat or wavy, etc.

“Label” means an identification marker constructed for attachment to an object through the use of an adhesive.

“Tag” means an identification marker constructed for attachment to an object through the use of fastening means, e.g., clips, wires, screws, ties, etc, other than an adhesive. Tags can also be attached to a wire by means of tabs or other parts of the tag itself.

“Wire marker” and like terms mean a label or tag that is attached to a wire or cable for purposes of identifying it and/or or its purpose.

“Ink” and like terms mean a coatable or printable formulation containing a dye and/or pigment.

“Halogen-free” and like terms mean that the labels and tags of this invention, sans the release liner, are without halogen content, i.e., contain less than 900 parts per million (ppm) chlorine and less than 900 ppm bromine and less than 1500 ppm combined chlorine and bromine, as measured by ion chromatography (IC) method or a similar analytical method. Halogen content of less than this amount is considered inconsequential to the burn emissions of the label or tag.

The invention is described generally with reference to the FIGURE for the purpose of illustrating certain embodiments only, and not for the purpose of limiting the scope of the invention.

The FIGURE is a schematic of one label embodiment of this invention. Halogen-free, wire-marking, multilayered label 10 comprises facestock layer 11 which comprises first or top facial surface 11a and second or bottom facial surface 11b. At least a part but less than all of facestock layer 11 is printed with topcoat layer 12 such that second or bottom facial surface 12b of topcoat layer 12 is in direct contact with top facial surface 11a. Beneath facestock layer 11 is optional adhesive layer 13 such that first or top facial surface 13a is in direct contact with bottom facial surface 11b. Beneath adhesive layer 13 is release liner 14 such that first or top facial surface 14a is in direct contact with bottom facial surface 13b. In a tag of similar construction, the adhesive layer and release liner are, of course, absent. The tag construction includes alternative means (not shown) for attaching the tag to the object to be marked. In the label construction of the FIGURE, top facial surfaces 11a and 12a and bottom facial surface 14b are open to the environment.

The facestock layer comprises at least one of PE and PP. Preferably, the facestock layer comprises a blend of PE and PP, typically at a weight ratio of PE to PP of greater than zero (>0) to less than 100 (<100), i.e., >0:<100, to <100:>0, preferably of 10:90 to 90:10. This layer is typically transparent or translucent, and its thickness is typically of 25 to 1000, preferably of 25 to 100, microns (μm).

The PE resins that can be used in the practice of this invention are well known, commercially available, free of halogen, and made by any one of a wide variety of processes including, but not limited to, solution, gas and slurry phase. These resins can be prepared with any one of a number of different catalysts, e.g., Zeigler-Natta, metallocene, etc.

The PP resins that can be used in the practice of this invention are also well known, commercially available, free of halogen, and made by any one of a wide variety of processes including, but not limited to, solution, gas and slurry phase. These resins can also be prepared with any one of a number of different catalysts, e.g., single-site, multiple-site, etc.

The topcoat layer comprises any material that will accept ink or other marking composition from a THT or laser printer. Typically the topcoat layer comprises an acrylate, and has a thickness of 1 to 10 μm. The topcoat covers at least a part of the top facial surface of the facestock layer, typically at least 10, preferably at least 20 and more preferably at least 30, percent of the total surface area of the top facial surface of the facestock layer. The topcoat covers less than 100, typically less than 80 and more typically less than 50, percent of the total surface area of the top facial surface of the facestock layer. This partial covering of the top facial surface of the facestock by the topcoat allows the label to be wound around a wire such that the non-covered top surface of the facestock can self-laminate over the printed images to form a protective layer.

If present, adhesive layer 13 can be applied to bottom facial surface 12b by any conventional means, e.g., lamination, printing, coating, etc. The adhesive is preferably a pressure sensitive adhesive (PSA). Many conventional pressure sensitive adhesives can be used in the practice of this invention and include but are not limited to acrylates, epoxies, silicates, natural and synthetic rubbers, etc., and these can e used either alone or in combination with one another. The thickness of the adhesive layer can vary to convenience, but it is typically of 12.5 to 60, preferably of 25 to 50, μm.

The construction of release liner 14 is not particularly important to the practice of this invention and its purpose, of course, is to protect the adhesive until the label is ready for application to an object. Examples of materials that can be used for the liner include glassine paper, laminated paper, polyester film, polypropylene film, polyethylene terephthalate (PET) film, preferably each of which has been subjected to a coating of silicone. Since the release liner is removed from the label and discarded before the label is attached to the wire, the release liner does not need to be halogen-free. The thickness of the liner layer can vary to convenience, but it is typically of 20 to 120, preferably of 40 to 100, μm.

The labels and tags of this invention can be constructed in any convenient manner. Typically, the topcoat is printed on the facestock using an appropriate method like flexographic, screen or gravure printing. The pressure sensitive adhesive is then either printed or laminated to the bottom planar surface of the facestock, and a liner is then applied to the exposed surface of the adhesive.

The label and tags of this invention possess good conformity such that the label or tag can be wrapped around a wire or cable, typically a cable that has a thickness greater than 2 millimeters (mm).

Although the invention has been described in considerable detail by the preceding examples and references to the drawings, this detail is for the purpose of illustration and is not to be construed as a limitation upon the spirit and scope of the invention as it is described in the appended claims. All patents and publications cited above, specifically including for U.S. practice all U.S. patents, allowed patent applications and U.S. Patent Application Publications, are incorporated herein by reference.

What is claimed is:

1. A halogen-free, wire-marking, multilayered label or tag comprising:
A. A facestock layer having top and bottom planar surfaces, the facestock layer comprising at least one of polyethylene and polypropylene;
B. A topcoat layer having top and bottom planar surfaces with the bottom planar surface of the topcoat layer in direct contact with at least a part but less than all of one of the top planar surface of the facestock layer;
C. An optional adhesive layer having top and bottom planar surfaces with the top planar surface of the optional adhesive layer in direct contact with at least part of the bottom planar surface of the facestock layer; and
D. An optional release liner having top and bottom planar surfaces with the top planar surface of the optional release liner in direct contact with the bottom planar surface of the optional adhesive layer.

2. The wire-marking, multilayered label or tag of claim 1 in which the facestock layer comprises a blend polyethylene and polypropylene.

3. The wire-marking, multilayered label or tag of claim 1 attached to a wire or cable having a thickness greater than 2 mm such that the uncovered portion of the facestock layer is laminated over the topcoat layer, and the adhesion of the topcoat layer to the uncovered portion of the facestock layer is such that the uncoated facestock layer can be removed from the facestock layer within the first 30 seconds of lamination without peeling off the topcoat layer from its underlying facestock layer.
